(19) United States
(12) Patent Application Publication
(10) Pub. No.: US 2013/0188045 A1
(43) Pub. Date: Jul. 25, 2013

(54) High Resolution Surveillance Camera

(71) Applicant: Ossi M. Kalevo, Toijala (FI)

(72) Inventor: Ossi M. Kalevo, Toijala (FI)

(73) Assignee: Nokia Corporation

(21) Appl. No.: 13/354,478

(22) Filed: Jan. 20, 2012

(51) Int. Cl. H04N 7/18

(52) U.S. Cl. 348/143; 348/E07.085

(57) ABSTRACT

The specification and drawings present a new method, apparatus and software related product (e.g., a computer readable memory) for security cameras/systems with wide angle lenses, high resolution image sensors and intelligent control, image processing and image/video storage. After capturing a high resolution image of the large area, downscaling and subsequent storage of the captured image is performed based on the determined importance levels of regions throughout the captured high resolution image.

### TECHNICAL FIELD

The exemplary and non-limiting embodiments of this invention relate generally to electronic camera devices and more specifically to security cameras/systems with wide angles lenses, high resolution image sensors and intelligent control/image processing.

### BACKGROUND ART

The following abbreviations that may be found in the specification and/or the drawing figures are defined as follows:
AWB Automatic White Balance
CCD Charge Coupled Device
CMOS Complementary Metal Oxide Semiconductor
FOV Field of View
HFOV Horizontal Field of View
JPEG Joint Photographic Experts Group
MPEG Moving Pictures Expert Group
PTZ Pan Tilt Zoom
QVGA Quarter VGA (320×240 pixel resolution)
QQVGA Quarter QVGA (160×120 pixel resolution)
VFOV Vertical Field of View
VGA Video Graphic Array (640×480 pixel resolution)

Security cameras are used to identify culprits and intruders as well as detecting what is happening in the environment. Security cameras can be wired or wireless and they can create notifications and store pictures/videos. Current security cameras are complex and expensive and/or they cannot record details requiring high resolution. A few solutions known in the art are briefly described below.

For example, video based surveillance with a fisheye wide-angle lens (e.g., PANASONIC) may provide predominantly low resolution pictures of intruders.

Moreover, a PCT Patent Application Publication No. WO2011002775 and a US issued U.S. Pat. No. 7,884,849 use multiple cameras. A wide-angle lens camera is used for object detection and a PTZ camera is used for actual recording purposes. This system is expensive and contains moving parts.

Furthermore, a PCT Patent Application Publication No. WO09108508 provides another solution. However, it is targeted only to video capture (e.g., with D1 resolution) and it requires separate analysis and recording of pictures. It also requires that the processing/separation of pictures are always in the camera module because of the bandwidth limitations for the full size image transfer to a processor or storing system.

### SUMMARY

According to a first aspect of the invention, a method comprising: receiving in an electronic device at least one high resolution image of a scene captured using a wide angle lens and an image sensor comprising a plurality of pixels; determining importance levels of regions throughout the at least one high resolution image; and downscaling at least one region of the at least one high resolution image using a first scaling factor if the determining has shown that the at least one region has a low importance level, and leaving at least one further region of the at least one high resolution image unscaled if the determining has shown that the at least one further region has a high importance level.

According to a second aspect of the invention, an apparatus comprising: at least one processor and a memory storing a set of computer instructions, in which the memory storing the computer instructions is configured with at least one processor to cause the apparatus to: receive in the apparatus at least one high resolution image of a scene captured using a wide angle lens and an image sensor comprising a plurality of pixels; determine importance levels of regions throughout the at least one high resolution image; and downscale at least one region of the at least one high resolution image using a first scaling factor if the determining has shown that the at least one region has a low importance level, and leaving at least one further region of the at least one high resolution image unscaled if the determining has shown that the at least one further region has a high importance level.

According to a third aspect of the invention, a method comprising: capturing by an electronic device at least one high resolution image of a scene using a wide angle lens and an image sensor comprising a plurality of pixels having between about 30 and about 800 megapixels; and transmitting the at least one high resolution image to a further electronic device for determining importance levels of regions throughout the at least one high resolution image and for selective scaling the regions in the at least one high resolution image based on the determining the importance levels of the regions.

According to a fourth aspect of the invention, an apparatus comprising: at least one processor and a memory storing a set of computer instructions, in which the memory storing the computer instructions is configured with at least one processor to cause the apparatus to: capture by an electronic device at least one high resolution image of a scene using a wide angle lens and an image sensor comprising a plurality of pixels having between about 30 and about 800 megapixels; and transmit the at least one high resolution image to a further electronic device for determining importance levels of regions throughout the at least one high resolution image and for selective scaling the regions in the at least one high resolution image based on the determining the importance levels of the regions.

### BRIEF DESCRIPTION OF THE DRAWINGS

For a better understanding of the nature and objects of the present invention, reference is made to the following detailed description taken in conjunction with the following drawings, in which:

FIG. 1 is an image captured using wide angle lens and high resolution image sensor with three regions having different importance levels with different scaling factors, according to an embodiment of the invention;

FIG. 2 is a flow chart demonstrating implementation of exemplary embodiments of the invention;

FIG. 3 is a block diagram of an electronic device (surveillance camera) for practicing exemplary embodiments of the invention; and

FIG. 4 is a block diagram of an electronic device (surveillance camera) and a processing device for practicing exemplary embodiments of the invention.

### DETAILED DESCRIPTION

A new method, apparatus, and software related product (e.g., a computer readable memory) are presented for security cameras/systems with wide angle lenses, high resolution image sensors and intelligent control, image processing and image/video storage. The image sensor may be, e.g., a high resolution CMOS or CCD with a number of pixels from about 20-30 Mpixels to about 800 Mpixels. A wide angle lens such as a fisheye lens or the like having, e.g., HFOV of 90 to 270 degrees and VFOV of 60 to 270 degrees and used for detecting a large area at once with a high resolution image sensor may enable detecting/recording a large amount of image data with a very high resolution (detail accuracy) about this large area. Subsequent intelligent processing may further enable optimization of storing of the large area images thus reducing system memory requirements, as further described herein.

According to an embodiment of the invention, a system architecture can use or require a high-speed interface between an image sensor/module (sensor module) and an image/application processor to enable, for example, capturing a full resolution image with the requested frame rate (e.g., 1 to 60 frames per second) to be provided to the image/application processor. The high-speed interface may have a throughput capability between about 1 and 100 Gb/s. The high-speed interface enables performing the signal processing part remotely from the sensor module, e.g., in an image processing module of the surveillance camera or in a remote processing device such as a computer with much larger computation power and storage capacity than the surveillance camera. The high speed interface may be implemented using a fiber-optic connection, a wired electrical connection or wireless means.

The analysis of the captured image may be performed in the image/application processor of the surveillance camera itself or in a separate/peripheral processing device. Also this analysis may be performed at least partially in the image sensor/module.

In another embodiment, both the image sensor/module (or sensor module) and the image/application processor may contain some processing capability that is needed for image scaling (e.g., U.S. Pat. No. 8,045,047, US Patent Application Publication No. 2011/0274349) and intelligent selecting/storing of multiple regions with different scaling ratios which is further discussed below. After appropriate scaling, the image final storage may be implemented only for important parts of the captured images.

The electronic device (e.g., surveillance camera) may capture at least one high resolution image (still or video frame) of a scene using a wide angle lens and an image sensor comprising a plurality of pixels. The image may be a raw image with a scaled or full/maximum resolution of the image sensor. The choice of the sensor resolution to be full/maximum or downscaled may depend on the application and may be provided to the surveillance camera through a user interface or set by default.

Then the detection of an object or objects in the captured images can be made based on the spatial and/or movement information. This may be implemented, for example, by determining importance levels of regions throughout the captured at least one high resolution image.

This determining may be performed by comparing the captured at least one high resolution image with at least one more (or several) high resolution image/images captured before the at least one high resolution image. The importance levels of regions may be determined by analyzing a change in at least one high resolution image which may comprise (but is not limited to) one or more of the following situations: an object is moving or starting to move, sudden appearance of a new object, any spatial change in any region of the at least one high resolution image, etc.

Then the further processing may include downscaling at least one region of the at least one high resolution image using a first scaling factor if the determining has shown that the at least one region has a low importance level, and leaving at least one further region of the at least one high resolution image unscaled if the determining has shown that the at least one further region has a high importance level.

In other words, in this example scenario there are two importance levels: low and high. Regions without a noticeable change are low importance regions and may be downscaled since they do not contain important information. These low importance regions may be used for displaying purposes, and may be saved for short-term use and/or discarded and not stored for a long term reference use. On the other hand, the high importance regions having high resolution may be left unscaled and may be used for extracting important detailed information if needed. The high importance regions then may be saved for the long term reference use.

In a further embodiment, there may be at least additional another importance level such as at least one intermediate importance level (e.g., between the low and high importance levels) to be used: for example when the changes observed in at least one additional region of the image are slow (e.g., below a preset change rate). In this scenario, the at least one additional region in the at least one high resolution image may be downscaled using a second scaling factor if the at least one other region has an intermediate importance level (between the low and high levels). In other words, a region with the intermediate importance level may be also downscaled, but even after downscaling can still have a relatively high resolution and contain important information. This additional region may be stored for possible future long term reference use.

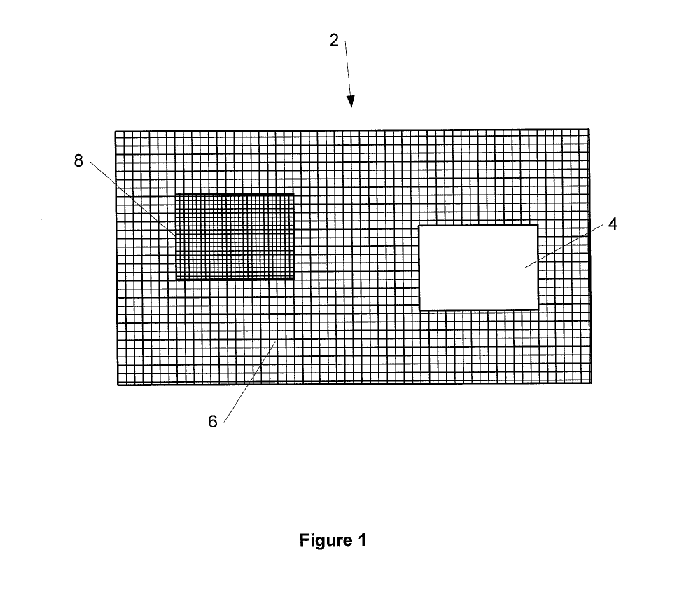

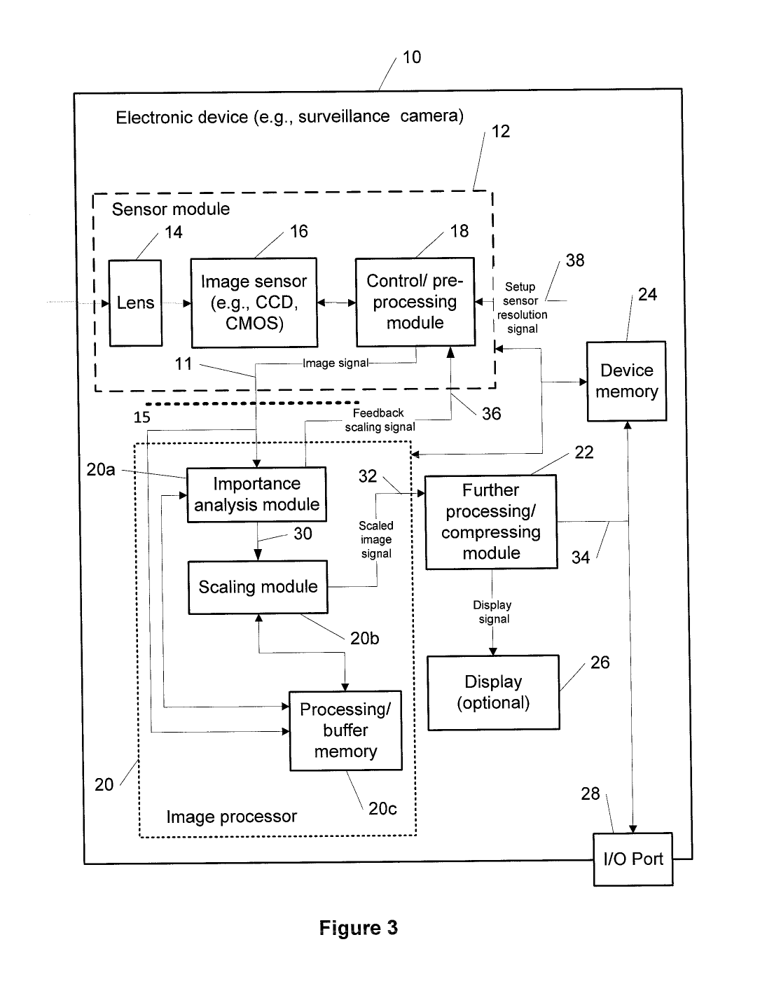

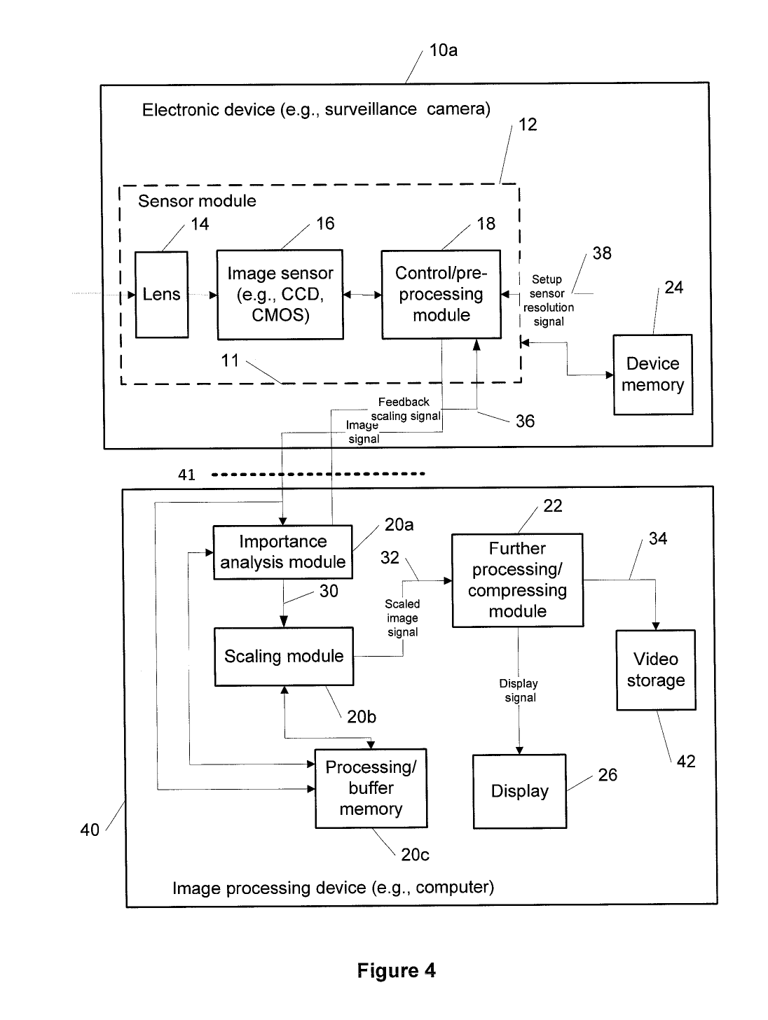

FIG. 1 shows an example of an image 2 captured using the wide angle lens and high resolution image sensor (shown in FIGS. 3 and 4) where three types of regions are identified: a high importance region 4 having high importance level and which is unscaled and has the highest resolution for storing, a low resolution region 6 having the lowest importance level and downscaled using the highest scaling factor which may be used for displaying purposes, and an intermediate importance region 8 having the intermediate importance level and downscaled with the intermediate scaling factor (less than the highest scaling factor) which may be also stored for possible future reference use. It is noted that the total image 2 may be also downscaled for displaying purposes in a parallel/complimentary processing.

As noted above, the raw image may be captured utilizing a full/maximum (where signals from all pixels of the sensor are presented in the image) or downscaled resolution of the image sensor. The choice of the full or downscaled resolution may depend on the application and may be provided to the surveillance camera through a user interface or set by default before starting to capture images. According to a further embodiment, sensor resolution for a next captured image (or a plurality of next images/frames) may be dynamically changed based on the results of the processing analysis described herein. For example, if the at least one high resolution image is captured without using a maximum resolution of the image sensor and if the determining has shown that the at least one region is the high importance region, then instructions may be provided for capturing the next high resolution image comprising this high importance region using the maximum (full) resolution or an increased resolution of the image sensor. This change in the sensor resolution may stay in effect until the condition determining the high importance level of the region is no longer present, and the sensor resolution may be then scaled back, e.g., if no high importance regions are identified in the following captured high resolution images.

It is further noted that according to the embodiments described herein, when the sensor resolution is changed due to the detected presence of the high importance region in the captured high resolution image, the scene to be captured in the next high resolution images stays the same as before (with the same FOV). In other words, “refocusing” on the identified high importance region by reducing FOV in the next image to that “high importance region” is not needed in the embodiments of the invention, so that the next high resolution image/frame allows surveillance of the same scene with the same FOV as before.

Moreover, even though according to the embodiments of the invention the refocusing for the next high resolution region (i.e., before capturing the next high resolution image of the same scene) is not provided, in one embodiment it is possible to provide a refined auto-focusing by using the identified high importance region as a reference point for the refined auto-focusing.

As stated above, the image regions having high importance and/or intermediate importance may be stored for future use. The size of the image data to be stored may be further reduced by downscaling/compression. Image/video compression for the recorded images/videos can be made within standardized image/video codec (e.g., JPEG, H.264, MPEG-4).

The embodiments described above provide a number of advantages, which may include (but are not limited to):
The system can record very high quality pictures and videos;
recorded object(s) having various FOV (small or large) may be identified;
the system requires only one image sensor/module;
system does not require moving parts; and
the architecture and processing is optimized and do not require large power and/or storage.

A feature of this embodiment is that the same image can be used for detection and identification purposes, and also for storing purposes, and the camera does not need to change the mode (e.g., no “refocusing” to the high importance region is needed) or limit the information.

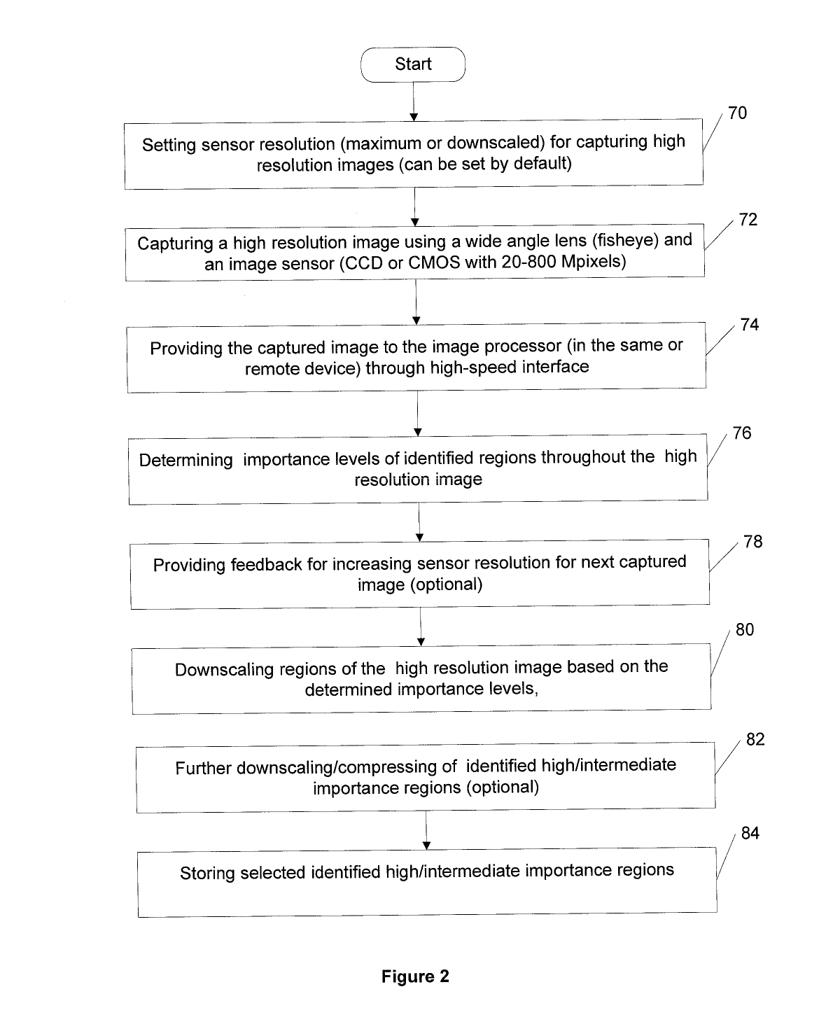

FIG. 2 shows an exemplary flow chart demonstrating implementation of embodiments described herein. It is noted that the order of steps shown in FIG. 2 is not absolutely required, so in principle, the various steps may be performed out of the illustrated order. Also certain steps may be skipped, different steps may be added or substituted, or selected steps or groups of steps may be performed in a separate application.

In a method according to the exemplary embodiments, as shown in FIG. 2, in a first step 70, a sensor resolution (maximum or downscaled) for capturing high resolution images is set through a user interface or alternatively by default. In a next step 72, a high resolution image with the set resolution is captured using a wide angle lens (e.g., a fisheye) and an image sensor (e.g., CCD or CMOS with 20-800 Mpixels). In a next step 74, the captured image is provided to the image processor (in the same or in a remote device) through a high-speed interface.

In a next step76, the importance levels (e.g., high, intermediate, low) of the identified regions are determined throughout the captured high resolution image based on the spatial and/or movement information. In a next optional step 78, a feedback for increasing image sensor resolution (if it is not already set to the maximum) for the next captured image/images may be provided. In a next step 80, identified regions of the high resolution image based on the determined importance levels are downscaled as described herein. In a next step 82, identified high/intermediate importance regions may be further downscaled/compressed if needed. In a next step 84, identified high/intermediate importance regions are stored for the future reference use.

FIG. 3 shows an example of a simplified block diagram of an electronic device 10 (e.g., a surveillance camera) for practicing the exemplary embodiments of the invention. The electronic device 10 comprises a sensor module 12 for capturing the high resolution image at the desired resolution (e.g., maximum sensor resolution) for implementing steps 70-74 shown in FIG. 2. The sensor module 12 comprises a wide angle lens 14 (e.g., a fisheye lens) which may be a fixed/non-exchangeable optical lens/assembly, an image sensor 16 (e.g., CCD or CMOS with 20-800 Mpixels), a control/pre-processing module 18 and a high-speed interface 15. The module 18 is used to control capturing the high resolution image of scene (using the lens 14 and the image sensor 16) with the desired sensor resolution set up using a signal 38. The module 18 performs the pre-downscaling of the raw sensor signal to provide an image signal 11 with the desired resolution (e.g., less than the maximum/full sensor resolution set by the signal 38) through the high-speed interface 15 to an image processor 20.

The image processor 20 performs signal processing to implement steps 76-80 shown in FIG. 2 using a processing/buffer memory 20c where received high resolution signal 11 may be temporarily stored for ongoing processing. The image processor 20 comprises an importance analysis module 20a for identifying regions in the captured high resolution image having different importance levels (e.g., high, intermediate, low). Also, the module 20a may provide a feedback scaling signal 36 to the control/pre-processing module 18 for increasing image sensor resolution (if it is not already set to the maximum) for the next captured image/images. Also the image processor 20 comprises a scaling module 20b for downscaling the identified regions of the high resolution image based on the determined importance levels as described herein (see FIG. 1) and providing the scaled image signal 32 to a further processing/compressing module 22.

The further processing/compressing module 22 may perform further standard processing such as automatic white balance (AWB), color interpolation, noise reduction and/or miscellaneous correction, etc. The module 22 may further downscale/compress the identified high and/or intermediate importance regions (e.g., for minimizing the storage needs) to store the output signal 34 in a device memory 24 and/or to send the signal 34 through an input/output port 28 to a remote storing/further use. It is noted that an optional display 26 may be used for displaying the captured high resolution image after being downscaled to a standard VGA, QVGA or QQVGA format in parallel/complimentary processing.

Various embodiments of the memory 24 or 20c (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 20 may include but are not limited to general purpose computers, special purpose computers, microprocessors, digital signal processors (DSPs) and multi-core processors.

The module 18, 20a, 20b or 22 may be implemented as an application computer program stored, e.g., in the memory 24, but in general it may be implemented as software, firmware and/or hardware module or a combination thereof. In particular, in the case of software or firmware, one embodiment may be implemented using a software related product such as a computer readable memory (e.g., a non-transitory computer readable memory), computer readable medium or a computer readable storage structure comprising computer readable instructions (e.g., program instructions) using a computer program code (i.e., the software or firmware) thereon to be executed by a computer processor.

Furthermore, the modules 16, 18, 20, 20a, 20b or 22 may each be implemented as a separate module/block or may be combined with any other module/block of the device 10 or split into several blocks according to their functionality. Moreover, it is noted that all or selected modules of the device 10 may be implemented using an integrated circuit (e.g., using an application specific integrated circuit, ASIC).

FIG. 4 shows an example of a simplified block diagram of an electronic device 10a (e.g., a surveillance camera) and a processing device 40 for practicing exemplary embodiments of the invention. The block diagram shown in FIG. 4 differs from the device 10 of FIG. 3 by the fact that most of the processing is performed remotely in a separate image processing device 40 (e.g., a computer) with a larger processing and storage capabilities than in the device 10 of FIG. 3. The wireless device 10a comprises a sensor module 12a for capturing the high resolution image of the desired resolution (e.g., maximum sensor resolution) for implementing steps 70-74 shown in FIG. 2, and the device memory 24.

The module 12a and the memory 24a are the same as the module 12 and the memory 24 in the device 10 of FIG. 3 in reference to their functionality as explained herein. However, in FIG. 4, the image signal 11 with the desired resolution is sent through the high-speed interface 41 (e.g., fiber-optic, wired or wireless interface) to an image processor device 40 which essentially performs the same steps 76-84 of FIG. 2 as the device 10 shown in FIG. 3, but with the larger processing and storage capabilities.

For example, a video storage 42 in the device 40 can have a higher storage capacity than the memory 24 in the device 10, and modules 20a, 20b and 20c in the device 40 have higher processing capabilities than corresponding modules in the device 10.

Since the modules in the devices 10a and 40 of FIG. 4 are practically the same (or similar) to the modules of the device 10 shown in FIG. 3, implementation details of the modules shown in FIG. 4 are the same as for (or similar to) the device 10 as described herein in reference to FIG. 3.

For example referring to FIG. 4, the module 20a, 20b or 22 may be implemented as an application computer program stored, e.g., in the memory 40, but in general it may be implemented as a software, a firmware and/or a hardware module or a combination thereof. In particular, in the case of software or firmware, one embodiment may be implemented using a software related product such as a computer readable memory (e.g., a non-transitory computer readable memory), computer readable medium or a computer readable storage structure comprising computer readable instructions (e.g., program instructions) using a computer program code (i.e., the software or firmware) thereon to be executed by a computer processor.

Furthermore, the module, 20a, 20b or 22 may be implemented as a separate block or may be combined with any other module/block of the device 40 or it may be split into several blocks according to their functionality. Moreover, it is noted that all or selected modules of the device 40 may be implemented using an integrated circuit (e.g., using an application specific integrated circuit, ASIC).

Also, the module 18 in the device 10a (FIG. 4) may be implemented as an application computer program stored, e.g., in the memory 24, but in general it may be implemented as a software, a firmware and/or a hardware module or a combination thereof. In particular, in the case of software or firmware, one embodiment may be implemented using a software related product such as a computer readable memory (e.g., a non-transitory computer readable memory), computer readable medium or a computer readable storage structure comprising computer readable instructions (e.g., program instructions) using a computer program code (i.e., the software or firmware) thereon to be executed by a computer processor.

Furthermore, the module 16 or 18 may be implemented as a separate block or may be combined with any other module/block of the device 10a or it may be split into several blocks according to their functionality. Moreover, it is noted that all or selected modules of the device 10a may be implemented using an integrated circuit (e.g., using an application specific integrated circuit, ASIC).

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

What is claimed is:

1. A method, comprising:
receiving in an electronic device at least one high resolution image of a scene captured using a wide angle lens and an image sensor comprising a plurality of pixels;
determining importance levels of regions throughout the at least one high resolution image; and
downscaling at least one region of the at least one high resolution image using a first scaling factor if the determining has shown that the at least one region has a low importance level, and leaving at least one further region of the at least one high resolution image unscaled if the determining has shown that the at least one further region has a high importance level.

2. The method of claim 1, wherein the at least one high resolution image is received from a further electronic device which captured the at least one high resolution image using the wide angle lens and the image sensor.

3. The method of claim 1, wherein the at least one high resolution image is received from a sensor module of the electronic device which captured the at least one high resolution image using the wide angle lens and the image sensor.

4. The method of claim 1, wherein the method further comprises:
downscaling at least one other region of the at least one high resolution image using a second scaling factor if the determining has shown that the at least one other region has an intermediate importance level, the intermediate importance level being between the low and high importance levels.

5. The method of claim 1, wherein the importance levels of the regions are determined by analyzing a change in at least one high resolution image which comprises one or more of: an object is moving or starting to move, sudden appearance of a new object and any spatial change in a region of the at least one high resolution image.

6. The method of claim 1, wherein the determining is performed by comparing the captured at least one high resolution image with at least one other high resolution image captured before the at least one high resolution image.

7. The method of claim 1, wherein a resolution for capturing the at least one high resolution image is preset through a user interface.

8. The method of claim 1, wherein the at least one high resolution image is a maximum resolution image of the image sensor, where signals from all pixels of the plurality of pixels are presented in the at least one high resolution image.

9. The method of claim 1, wherein the at least one high resolution image is captured without using a maximum resolution of the image sensor and if the determining has shown that the at least one further region has the high importance level, the method further comprises:
providing instructions for capturing a next high resolution image using a maximum resolution or an increased resolution of the image sensor.

10. The method of claim 1, wherein the at least one high resolution image is a part of a video stream having a frame rate.

11. The method of claim 1, further comprising:
storing data for the at least one further region having the high importance after said downscaling.

12. The method of claim 1, further comprising:
further compressing the at least one image after said downscaling; and
storing data for the at least one further region having the high importance after said downscaling and compressing.

13. An apparatus, comprising:
at least one processor and a memory storing a set of computer instructions, in which the processor and the memory storing the computer instructions are configured to cause the apparatus to:
receive in the apparatus at least one high resolution image of a scene captured using a wide angle lens and an image sensor comprising a plurality of pixels;
determine importance levels of regions throughout the at least one high resolution image; and
downscale at least one region of the at least one high resolution image using a first scaling factor if the determining has shown that the at least one region has a low importance level, and leaving at least one further region of the at least one high resolution image unscaled if the determining has shown that the at least one further region has a high importance level.

14. The apparatus of claim 13, wherein:
the plurality of pixels in the image sensor comprise between about 20 and about 800 megapixels, and.
for the wide angle lens a horizontal field of view is between about 90 and about 270 degrees, and a vertical field of view is between about 60 and about 270 degrees.

15. The apparatus of claim 13, wherein the image sensor is a charge coupled device or a complementary metal oxide semiconductor.

16. The apparatus of claim 13, wherein he computer instructions are configured further to cause the apparatus to:
store data for the at least one further region having the high importance after at least said downscaling.

17. A method, comprising:
capturing by an electronic device at least one high resolution image of a scene using a wide angle lens and an image sensor comprising a plurality of pixels having between about 30 and about 800 megapixels; and
transmitting the at least one high resolution image to a further electronic device for determining importance levels of regions throughout the at least one high resolution image and for selective scaling the regions in the at least one high resolution image based on the determining the importance levels of the regions.

18. The method of claim 17, further comprising:
storing data for the at least one further region having the high importance after at least said downscaling.

19. An apparatus, comprising:
at least one processor and a memory storing a set of computer instructions, in which the processor and the memory storing the computer instructions are configured to cause the apparatus to:
capture by an electronic device at least one high resolution image of a scene using a wide angle lens and an image sensor comprising a plurality of pixels having between about 30 and about 800 megapixels; and
transmit the at least one high resolution image to a further electronic device for determining importance levels of regions throughout the at least one high resolution image and for selective scaling the regions in the at least one high resolution image based on the determining the importance levels of the regions.

20. The apparatus of claim 19, wherein the apparatus does not have a display.

21. The apparatus of claim 19, wherein the wide angle lens is fixed and non-exchangeable.
